(19) United States
(12) Patent Application Publication
(10) Pub. No.: US 2021/0387734 A1
(43) Pub. Date: Dec. 16, 2021

(54) INTEGRATED SEAT PAN CUSHION STRUCTURE

(71) Applicant: B/E Aerospace, Inc., Winston-Salem, NC (US)

(72) Inventors: Sreekanth Koti Ananda Rao, Chikkalasandra (IN); Rithukiran Vijayan, Vidyaranyapura Post. (IN); Nakul Gupta, Dwarka (IN)

(21) Appl. No.: 17/320,499

(22) Filed: May 14, 2021

(30) Foreign Application Priority Data
Jun. 13, 2020 (IN) 202041024886

(51) Int. Cl. B64D 11/06; A47C 7/26; A47C 7/14

(52) U.S. Cl. CPC B64D 11/0647; B33Y 80/00; A47C 7/14; A47C 7/26

(57) ABSTRACT

A completely integrated metallic seat pan with a negative stiffness includes a seat pan base, an internal metallic lattice, and a metallic seat pan cover surrounding the metallic lattice. The metallic lattice and seat pan cover elastically deform to absorb the weight of the crewmember and provide cushioning. The seat pan cover is contoured. Portions of the contoured seat pan cover may have greater or lesser cross-sectional thickness to provide variable negative stiffness at different locations on the seat pan.

### PRIORITY

The present application claims the benefit under 35 U.S.C. § 119(a) of Indian App. No. 202041024886 (filed Jun. 13, 2020), which is incorporated herein by reference.

### BACKGROUND

Cabin attendant seat pan assemblies are generally made of multiple layers: a cushion composed of multiple layers of foam, a plastic seat-pan insert, and seat-pan cover attached to a seat pan base. Materials and manufacturing are expensive. Non-metallic parts including the foam and fabric covers are subjected to flammability and toxicity requirements. Furthermore, the foam cushion, including the plastic seat pan insert, has negligible impact absorption.

### SUMMARY

In one aspect, embodiments of the inventive concepts disclosed herein are directed to a completely integrated metallic seat pan which offers a negative stiffness. The integrated seat pan has a seat pan base with an internal metallic lattice structure. The seat pan base has a smooth outer surface providing a comfortable seating area acting as a seat pan cover for the occupant. The integrated seat pan with an inbuilt lattice structure elastically deforms to absorb the weight of the crewmember and provide cushioning.

In a further aspect, the seat pan surface is contoured. Portions of the contoured seat pan cover may have greater or lesser cross-sectional thickness to provide variable negative stiffness at different locations on the seat pan.

It is to be understood that both the foregoing general description and the following detailed description are exemplary and explanatory only and should not restrict the scope of the claims. The accompanying drawings, which are incorporated in and constitute a part of the specification, illustrate exemplary embodiments of the inventive concepts disclosed herein and together with the general description, serve to explain the principles.

### BRIEF DESCRIPTION OF THE DRAWINGS

The numerous advantages of the embodiments of the inventive concepts disclosed herein may be better understood by those skilled in the art by reference to the accompanying figures in which:

FIG. 1 shows a perspective, exploded view of an aircraft cabin attendant seat;

FIG. 2 shows a perspective view of an integrated seat pan according to an exemplary embodiment;

FIG. 3 shows a front, cross-sectional view of an integrated seat pan according to an exemplary embodiment;

FIG. 4A shows a perspective view of an integrated seat pan according to an exemplary embodiment;

FIG. 4B shows a front, cross-sectional view of an integrated seat pan according to an exemplary embodiment; and

FIG. 4C shows a top, cross-sectional view of an integrated seat pan according to an exemplary embodiment.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination of sub-combination of two or more such features, along with any other features which may not necessarily be expressly described or inherently present in the instant disclosure.

Broadly, embodiments of the inventive concepts disclosed herein are directed to a completely Integrated seat pan with a negative stiffness. The Integrated seat pan has an intrinsic metallic lattice structure, and a smooth outer surface which provides a comfortable seating area to the occupant. The Integrated seat pan with intrinsic metallic lattice elastically deforms to absorb the weight of the crewmember and provide cushioning.

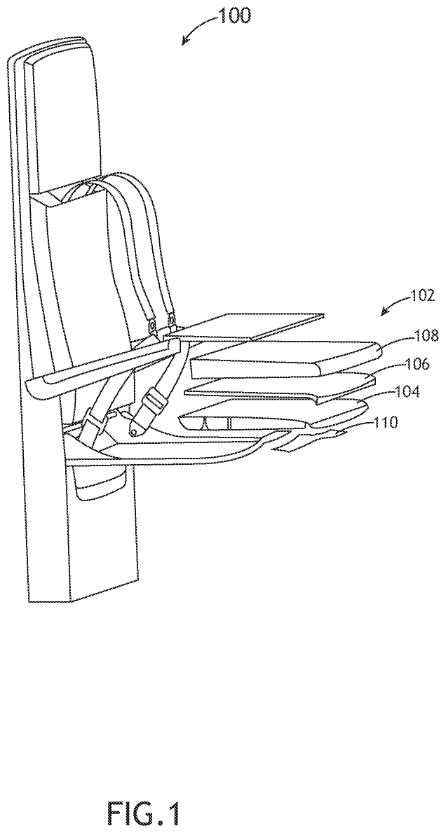

Referring to FIG. 1, a perspective, exploded view of an aircraft cabin attendant seat 100 is shown. State of the art seat pans 102 comprise a plastic seat pan insert 104, one or more foam layers 106, and a seat pan cover 108. The assembly may be affixed to the aircraft cabin attendant seat 100 via seat pan tape 110.

Non-metallic portions of the seat pan 102, 106, 108, 110 require flammability and toxicity testing which may be expensive, especially whenever new materials are employed. Furthermore, assembly requires some amount of labor.

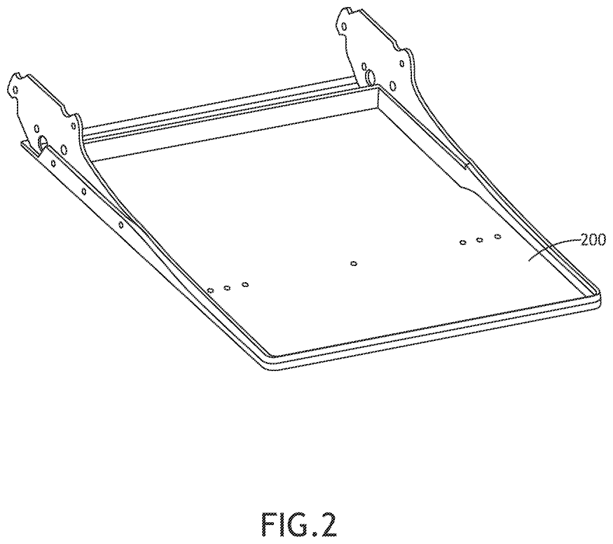

Referring to FIG. 2, a perspective view of an integrated seat pan 200 according to an exemplary embodiment is shown. The integrated seat pan 200 is a singular metal component. A singular metal component does not require the same testing and certification as a composite seat pan with non-metallic components.

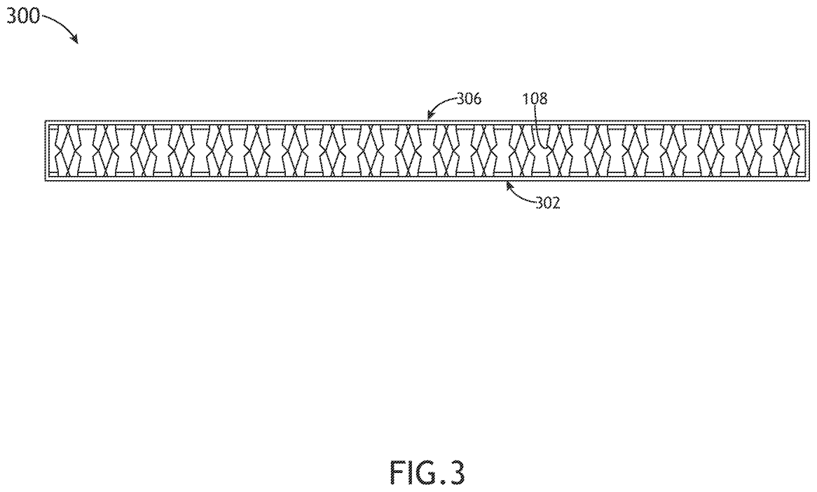

Referring to FIG. 3, a front, cross-sectional view of an integrated seat pan 300 according to an exemplary embodiment is shown. The integrated seat pan 300 comprises a solid seat pan base 302 portion, an intrinsic metallic lattice 304 portion disposed on the solid seat pan base 302 portion, and smooth outer surface integrated with the intrinsic metallic lattice 304 portion and seat pan base 302 portion to act as a solid seat cover 306 portion. In at least one embodiment, the seat cover 306 portion completely surrounds the intrinsic metallic lattice 304 portion.

In at least one embodiment, the integrated seat pan 300 is produced via an additive manufacturing process. The seat pan base 302 portion, metallic lattice 304 portion, and seat cover 306 portion may be one singular metallic component.

In at least one embodiment, the integrated seat pan 300 defines a negative stiffness. The cross-sectional thickness of the seat cover 306 portion, and the structure and disposition of the metallic lattice 304 portion define elastically deformable portions of the integrated seat pan 300 to provide some amount of cushioning and energy absorption.

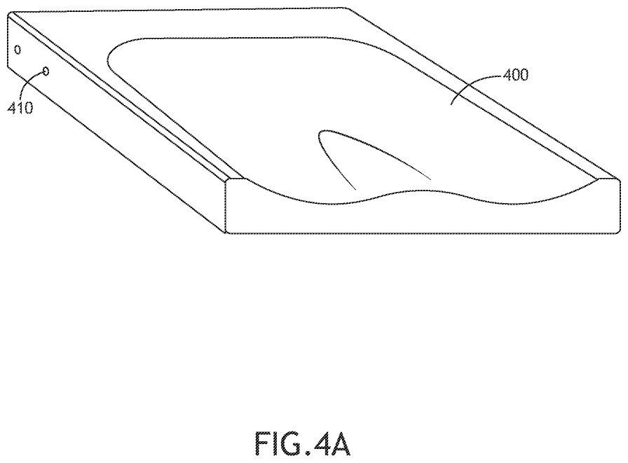

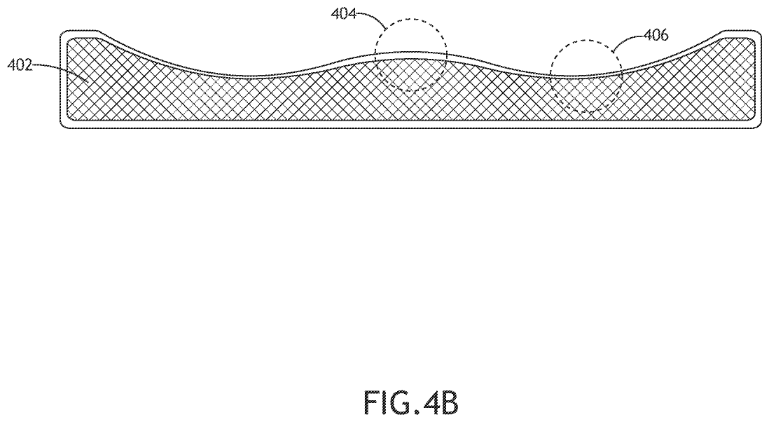

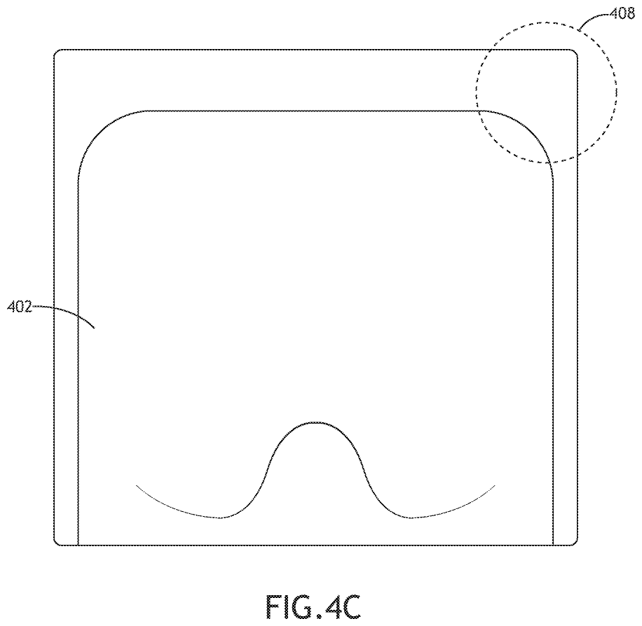

Referring to FIGS. 4A-4C, a perspective view; a front, cross-sectional view; and a top, cross-sectional view of an integrated seat pan according to an exemplary embodiment are shown. In at least one embodiment, the integrated seat pan defines a contoured portion in a seat cover. The contoured portion 400 may correspond to regions of variable cross-sectional thickness 404, 406 in the solid surface of the seat cover. Variable cross-sectional thicknesses 404, 406 may alter the relative degree of deformability in portions of the integrated seat pan requiring more or less cushioning.

The contoured portion 400 may alter the disposition of the interior metallic lattice 402. Furthermore, the metallic lattice 402 may define internal regions of differing lattice structure to produce more or less cushioning via different local negative stiffness.

In at least one embodiment, the integrated seat pan may define one or more solid regions 408. The integrated seat pan may need to be affixed to a corresponding aircraft cabin attendant seat. Such fixation may be by attaching the integrated seat pan to a preexisting plate, but may also be by fixation elements such as screws. The integrated seat pan may therefore define connecting elements 410 in the one or more solid regions 408 where the integrated seat pan can be secured to the aircraft cabin attendant seat.

It may be appreciated that a negative stiffness metallic lattice 402 may be more energy absorbent in an impact that traditional foam cushions. An integrated seat pan has the cushioning effect inbuilt via the negative stiffness of the lattice structure 402.

In at least one embodiment, the integrated seat pan is produced via an additive manufacturing process. The integrated seat pan may comprise AlSi10Mg; furthermore, the integrated seat pan may be heat treated according to a T6 process.

It may be appreciated that while components of the seat pan have been discussed in isolation, it is envisioned that the seat pan would be manufactured as a singular element with all of the components integrated. Manufacturing an integrated seat pan according to the present disclosure may cost half as much as a traditional seat pan cushion. Furthermore, an integrated metal seat pan does not require flammability or toxicity testing and certification. Finally, an integrate seat pan is simpler to assemble and mount directly on the seat.

It is believed that the inventive concepts disclosed herein and many of their attendant advantages will be understood by the foregoing description of embodiments of the inventive concepts disclosed, and it will be apparent that various changes may be made in the form, construction, and arrangement of the components thereof without departing from the broad scope of the inventive concepts disclosed herein or without sacrificing all of their material advantages; and individual features from various embodiments may be combined to arrive at other embodiments. The form herein before described being merely an explanatory embodiment thereof, it is the intention of the following claims to encompass and include such changes. Furthermore, any of the features disclosed in relation to any of the individual embodiments may be incorporated into any other embodiment.

What is claimed is:

1. An aircraft seat comprising:
a seat pan base;
a metallic lattice disposed on the seat pan base; and
a seat cover disposed on the metallic lattice.

2. The aircraft seat of claim 1, wherein the metallic lattice comprises an AlSiMg alloy.

3. The aircraft seat of claim 2, wherein the metallic lattice is T6 heat treated.

4. The aircraft seat of claim 1, wherein the seat cover defines one or more contoured portions.

5. The aircraft seat of claim 4, wherein the contoured portions define variable cross-sectional thicknesses.

6. The aircraft seat of claim 1, wherein the metallic lattice defines a negative stiffness.

7. An integrated aircraft seat pan comprising:
a seat pan base portion;
a metallic lattice portion disposed on the seat pan base portion; and
a seat cover portion disposed on the metallic lattice portion,
wherein the seat pan base portion, metallic lattice portion, and seat cover portion comprise a singular integrated component.

8. The integrated aircraft seat pan of claim 7, wherein the metallic lattice portion comprises an AlSiMg alloy.

9. The integrated aircraft seat pan of claim 8, wherein the metallic lattice portion is T6 heat treated.

10. The integrated aircraft seat pan of claim 7, wherein the seat cover portion defines one or more contoured portions.

11. The integrated aircraft seat pan of claim 10, wherein the contoured portions define variable cross-sectional thicknesses.

12. The integrated aircraft seat pan of claim 7, wherein the metallic lattice portion defines a negative stiffness.

13. The integrated aircraft seat pan of claim 7, wherein the seat pan base portion and seat cover portion define one or more non-metallic lattice portion portions configured to receive connection elements to connect the seat pan base portion, metallic lattice portion, and seat cover portion to a seat frame.

14. An additively manufactured integrated aircraft seat pan comprising:
a seat pan base portion;
an intrinsic metallic lattice portion disposed on the seat pan base portion; and
a smooth outer surface which act as a seat cover portion disposed on the metallic lattice portion.

15. The additively manufactured integrated aircraft seat pan of claim 14, wherein the metallic lattice portion comprises AlSiMg.

16. The additively manufactured integrated aircraft seat pan of claim 15, wherein the metallic lattice portion is T6 heat treated.

17. The additively manufactured integrated aircraft seat pan of claim 14, wherein the seat cover portion defines one or more contoured portions.

18. The additively manufactured integrated aircraft seat pan of claim 17, wherein the contoured portions define variable cross-sectional thicknesses.

19. The additively manufactured integrated aircraft seat pan of claim 14, wherein the metallic lattice portion defines a negative stiffness.

20. The additively manufactured integrated aircraft seat pan of claim 14, wherein the seat pan base portion and seat cover portion define one or more non-metallic lattice portion portions configured to receive connection elements to connect the seat pan base portion, metallic lattice portion, and seat cover portion to a seat frame.
